(19) United States
(12) Patent Application Publication
(10) Pub. No.: US 2011/0250405 A1
(43) Pub. Date: Oct. 13, 2011

(54) Decorative and protective system for wares

(76) Inventor: Hank Sawatsky, Wiarton (CA)

(21) Appl. No.: 12/662,302

(22) Filed: Apr. 9, 2010

(51) Int. Cl. B32B 1/00; B05D 1/18; B05D 1/30; B41J 2/01; B05D 3/06; B05D 1/36; B05D 3/02; B05D 1/02; B05D 5/00

(52) U.S. Cl. 428/174; 427/427.4; 427/430.1; 427/420; 427/256; 427/512; 427/514; 427/407.2; 427/508; 427/389.7; 427/493; 347/102

(57) ABSTRACT

A copolymer Tradenamed HexiLok is applied in the form of an ink as a decorative and protective outer covering to glassware and other tableware. It serves also as an adhesion coating to which a cross-linked ethylene acrylic acid copolymer is applied, to serve as a shock absorber and shard retention agent, in the event of breakage of the wares. The impact resistance of drinking glasses can be improved ten-fold with a 5 mil outer coating. The use of UV light as a curing agent in a 2-stage curing process, enables high production rates. The tough HexiLok ink serves to hermetically seal the decorated surface of the wares, enabling the use of non-FDA approved decorating agents.

### CROSS REFERENCE TO RELATED APPLICATIONS

U.S. Pat. No. 6,346,315 Feb. 12, 2001 SAWATSKY; U.S. Pat. No. 6,699,352 Mar. 2, 2004 SAWATSKY

### BACKGROUND OF THE INVENTION

1. This invention is directed to an enhancement coating that is applied to household and other wares, as both a decorative and protective coating. The subject coating is of particular importance in its safety implications, with particular regard to frangible wares.

2. Widespread use is currently made of protective coatings on articles that are susceptible of damage, and that become dangerous to users and third parties when damaged. Tableware of glass, china, and clay are highly susceptible to breakage. Glassware in particular can be manufactured at low cost, is hard-wearing, sanitary, and readily washed, but is extremely frangible, and fractures with dangerously sharp edges. China wares are more expensive, but have similar characteristics to glassware. Clayware (pottery) is usually weaker than glassware, but is somewhat less dangerous when broken. This group of frangible wares are in need of protection, to increase their strength, and to reduce the danger that they present when they fragment. The decoration of this class of wares that are associated with human consumption of food and drink is significantly limited by the small number of available inorganic pigments that can be safely used in the manufacturing processes. There is increasing concern about the safety of inorganic pigments and the possibility of them having carcinogenic characteristics.

Lead pigments are prohibited by FDA regulations.

The current use of Cadmium in ceramic ink is being reviewed, and furthermore, the Federal Government is recognizing the problem and is proposing to subsidize glass, ceramic and metal decorating companies to make the changeover to a safer decoration process. The present invention is the only presently known alternative that is available to these companies, that meets Government safety criteria.

Most of the existing decorative processes are slow, expensive and labour and energy intensive, and do not lend themselves to automation. Also, the required production facilities are also both extensive and expensive.

### BRIEF SUMMARY OF THE INVENTION

The present invention is directed a process for applying a new organic copolymer, trade name HexiLok in protective relation to glass, ceramics and metals, using the processes set forth in the inventor's above-identified two earlier patents, adapted for that purpose. The HexiLok™ copolymer is very tough, and has excellent adhesion to glass, ceramics and metals. In addition to making glassware highly break resistant, the HexiLok also serves to hermetically seal-off the underlying surfaces, thereby enabling the safe utilization of a wide range of decorative inorganic pigments that would normally be unacceptable for such usage.

In addition to adapting the inventor's two earlier processes to the application of the HexiLok protective coating, the two processes are also adapted for the safe application of the extended range of inorganic pigments to the wares, prior to the application of the HexiLok coating.

### BRIEF DESCRIPTION OF THE SEVERAL VIEWS OF THE DRAWINGS

Certain embodiments of the invention are described by way of illustration, without limitation thereto other than as set forth in the accompanying claims, reference being made to the accompanying drawings, wherein:

FIG. 1 is a three-stage block diagram relating to colouring glass by the present process;

FIG. 2 is a three-stage block diagram relating to decorating glassware, ceramic or metal by the present process;

FIG. 3 is a seven-stage block diagram relating to preparing break-resistant glassware by the present process; and,

FIG. 4 is a nine-stage block diagram relating to preparing break-resistant decorated composites by the present process.

### DETAILED DESCRIPTION OF THE INVENTION

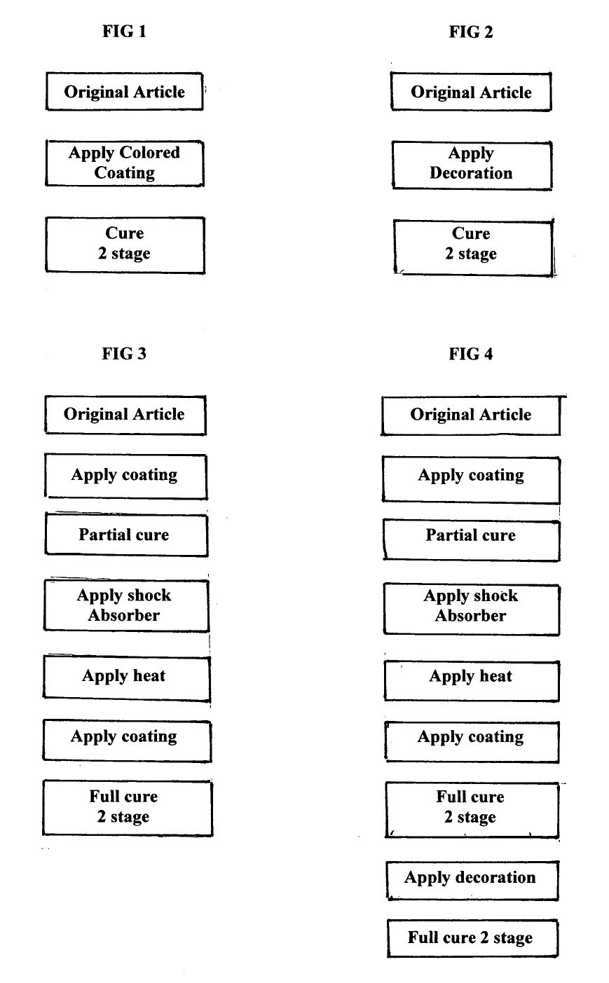

The process of FIG. 1 is directed to the application of colour to glassware, such as a hollow vessel, e.g a drinking glass.

In the second stage of FIG. 1, a hard outer protective, colored HexiLok coating is applied to an original, undecorated article. An alternative formulation of HexiLok can be used, which eliminates the need for the second stage heat cure, but results in reduced durability of the ink and coatings. The copolymer HexiLok™ is newly developed and can be used both as a protective coating and as an ink. The exact details of its composition are a trade secretbut it is vaguely described as a combination of epoxy and acrylic resins and is made by Collins Ink in Cincinatti, Ohio.

The surface of the article is compatible with the acrylic and epoxy copolymer being applied such that there is bonding of the copolymer directly to the surface of the article. The HexiLok acrylic component of the coating on the article is instantly cured with UV light, then the epoxy component of the copolymer is fully cured by the application of infrared heat for 2 minutes at maximum 300 deg. F.

HexiLok has unusually good adhesion characteristics, is glossy, scratch resistant and dishwasher safe. Both the copolymer and the dyes are organic and are regarded as being food safe.

The HexiLok copolymer, for spraying, dip coating or flow coating may be solvent based. In the process of FIG. 2, for decorating glassware, ceramic or metal, decoration is directly applied to the article, preferably by Digital Ink Jet printing, using a non solvent HexiLok ink which is formulated with the plastic copolymer described in FIG. 1. Five digital process colors, white, cobalt, magenta, yellow and black are applied by a DIJ high speed printer. It is essential that a virtually solid white HexiLok ink background is first applied, not only on clear articles such as glass but also on all products, regardless of color so that the 4 digital colors applied over the white background are predictable for color matching the graphics.

As each color, as well as white, is applied, the acrylic component is immediately at least partially cured with UV light and further UV cured after the complete graphics have been applied to the article, followed by infrared heat for 2 minutes at a maximum temperature of 300 deg. F. The end result is a tough, durable decoration having the same composition as the coating described in FIG. 1, which will readily withstand 30 household dishwashings.

In the process of FIG. 3, for providing break-resistant glassware, the same solvent based HexiLok coating as described in FIG. 1 is applied to the original article, preferably by spraying, or dip, or flow coating and UV cured, leaving the epoxy component uncured. A “shock absorber” is then applied by a powder coating process, using a finely ground powder of ethylene acrylic acid copolymer. The coated article travels through an oven which melts the powder, forming a smooth clear coating which bonds to the previously applied HexiLok coating and at the same time cures the second, epoxy component of the first coating. The thickness of the “shock absorber” can be selected to achieve various degrees of break resistance. The impact resistance of drinking glasses can be improved ten-fold with a 5 mil composite outer coating.

Finally, a clear or colored HexiLok coating, of the same composition as the first coating, is applied, preferably by spraying, followed by curing, first by 1 second of UV light, then 2 minutes in a 300 deg. F. oven.

In the process of FIG. 4 the process is the same as that described in FIG. 3 except the article is decorated, preferably by a high speed Digital Ink Jet (DIJ) 5 color printer. UV curing is accomplished by a new unique method: a UV-emitting LED unit travels with the product being decorated and instantly UV cures the HexiLok ink that has just been applied to the article being printed. After the 5 colors have been applied to the article it is then passed through a 300 deg. F. tunnel for 2 minutes.

Coating processes using HexiLok inks and coatings, or equivalent products, may be applied to a wide range of materials and shapes, using a variety of methods to apply the coatings including DIJ printing, spraying, flow coating or dip coating. The processes are thought to be of particular value in dealing with cylindrical articles, extending to include the decoration of objects such as ball-point pens.

An important aspect of the present invention is its applicability to wares associated with the handling and consumption of food and drink, that are subject to FDA regulation. The hermetic encapsulation of the applied decoration enables the use of organic coloring materials that would previously have been unacceptable by the FDA from a health and safety point of view. The subsequent application of a bonded, protective clear coating hermetically seals and protects the applied decorative matter.

A further important safety aspect of the present invention is the protective aspect of the subject process, as it applies for instance in the case of drinking glasses or tumblers. Using the subject process, the fracture-resistance factor (“frac-R”—resistance to fracture) of a tumbler can be increased as much as tenfold in some instances, compared with the uncoated article, by the application of a relatively thick protective coating in accordance with the present invention.

Alternatively, the frac-R can be increased by a more modest factor of say three to four, but with an associated improvement in the fragment-retentability characteristic of the coating, such that when fragmentation occurs, the dispersion of glass particles and shards is significantly limited: i.e. the particles and shards are held by the plastic coating. The desired compromise between these two protective aspects can be predetermined by precise control of the thickness of the protective coating, which control is made possible by the present process.

One embodiment of the subject process employs spraying, dip coating or flow-coating to apply one or more of the coatings. Such coatings may include tinting colors, to give the appearance of colored glass. The tinting color may be integrated with the first, adherence promoting coating. This encapsulation of the applied decoration enables the use of organic coloring materials that would previously have been unacceptable from a health and safety point of view.

The subject coating process may be used in combination with many modes of printing, including a variety of digital printing processes, particularly Digital Ink Jet (DIJ) printing.

The subsequent application of a bonded, protective clear coating can then hermetically seal and protect the applied decorative matter.

Such protective coatings are usually tougher than the undercoating, with a hard, abrasion resistant outer surface. It will be understood that the terms “decoration” and “decorative matter” encompasses prosaic matter including warning notices and other text, as well as including the application of a full color coating.

The clear nature of the available coatings renders them virtually visually undetectible to the naked eye.

For other wares having colored, decorated or marked surfaces that are susceptible to wear or damage, the application of the subject protective coating can greatly extend the effective life of such wear-susceptible surfaces. Selection of coatings, for either printing upon or as an outer, protective coating is determined by the desired qualities such as Food Use approval, impact resistance, dish washer safe, surface wear resistance (hardness and toughness); etc.

The respective coatings are preferably cured with ultraviolet light (UV). In the case of the outer surfaces of drinkware, this involves the use of “food contact approved” UV curable coatings.

The range of UV. cured protective outer coatings extends to include, but is not limited to polyesters and other polymers, polyurethanes and acrylates having the desired visual and protective qualities, and being effective in some instances at raised temperatures, some in excess of 300 F. degrees.

In some instances, for materials such as some plastics, an initial coating to accept ink may not be required, enabling the desired decoration to be applied directly to the surface of the plastic, as by DIJ printing.

In instances where a number of colors are involved, these may be individually applied in successive imprints, with UV curing after each imprint in some instances. The first step of decorating, such as by way of applying printed matter, is to define the precise location, shape and size of the decoration to be applied, by applying a background color to cover the precise decoration area. This background color is usually white, being a neutral color, so as not to adversely affect the colors specified for application in the decoration, which will be applied on top of the background.

The artwork is based upon the designer's “Bit Map Image” [BMI], which defines the respective areas for the application of the individual colors that will constitute the final art work.

For instance, on the basis of a designer's BMI, with a specified process color as an example, a sequence of Cyan, Yellow, Magenta and Black would each be individually printed.

Each individual color printing would be on the precise areas programmed in the BMI for that color.

DIJ printers lend themselves ideally to this use, being enabled by way of the present invention to print directly onto the subject article, with consequent improvements both in quality and in rate of output.

The end result is a full color print, with the respective colors in precise registry, in accordance with the BMI.

Depending on the nature of the inks being applied, curing may not be necessary after each printing step. If so required, U.V. curing as disclosed herein provides many advantages. The use of computer-controlled DIJ printers permit precise and ready changes such that changes to a processing line to accommodate different articles may be rapidly carried out, enabling high plant utilization, for a variety of products and decorations.

In the case of products such as glass tumblers and ceramic mugs this represents a vast improvement over existing decorative processes.

A great many benefits accrue from the use of UV curable inks with DIJ printing.

The outer coating can be in the order of 0.5 mil (0.0005 inches) and greater.

This capability may be combined in many instances with several varieties of DIJ printing, in the decorating and protection of an extremely wide range of products.

The adoption of UV curing usually implies the need for controlled ventilation, in view of the generation of fumes and vapor of limited toxicity.

The above described characteristics enable the application of coatings for both wear and decorating upgrades to a wide field of items, including items of household and personal use, by way of high speed automated processes, thus enabling competitive pricing in the market.

Such coatings may be decorative, or clear and primarily protective. Decoration would normally also be protected with a hermetic protective overcoat. In some instances, the decoration may be plain color.

In other instances spray coating or dip coating may be utilized. Thus, bowls that are not suited to rotation upon a mandrel may be spray coated, and dip coating may well be applied to scratched bulk articles such as beer bottles, to extend their useful service life. The foregoing wide scope of coating and decorating methods enables protective coatings, print-receptive undercoatings, and encapsulating protective outer coatings to be applied to a wide range of article shapes, including cylindrical, conical, flat and irregular surfaces, as well as localized or “spot” surfaces.

Furthermore, the subject processes are economical in terms of material utilization, speed and plant requirements.

Some examples of wares that may be protected and decorated by the subject processes include: Dinnerware and kitchen utensils including: glass, ceramic, plastic, pottery, china, porcelain, metal and composites in the form of plates, bowls, cups saucers, presentation plates, ornaments and figurines, etc; drinkware consisting of: mugs of ceramic, glass, plastic and metal; wine goblets of glass and plastic; tumblers of glass and plastic; sport bottles and travel mugs of plastic and stainless steel.

Serveware includes the above materials and also wood, as in trays, pitchers, bowls, plates, vases, candleholders, etc.

In the case of DIJ printing, multiple colors may be applied simultaneously, thus obviating the former, unduly labor intensive work of re-indexing to the applicator the imprint area for each successive color.

The jets of ink from a DIJ printing head may be directed onto a flexible silicone sheet, from which the ink pattern is then transferred to a convex shaped pad and applied by contact displacement to the desired printing area.

As referred to above, the imprinted area may have been previously prepared by the application of an ink-receptive undercoat.

For articles that can be mounted upon rotating mandrels, flow coating may be the preferred method for applying an overall coating.

In one embodiment for coating fairly thin planar articles, such as ceramic tiles, a digital ink jet printer may be used to apply decoration and, with a separate, serially arranged DIJ machine or machines, any desired undercoat and/or outer protective coat may be applied.

U.V. curing is readily provided, interposed between the serially arranged DIJ machines. In view of presently available DIJ machines of small size, such an arrangement may be provided as a process line located within an elongated fume cupboard, to deal with any fumes generated by the UV curing portion of the process.

It will be understood by those skilled in the art that the above disclosure is directed primarily to specific embodiments of the present invention, and that the subject invention is susceptible of reduction to practice in other embodiments that fall within the scope of the appended claims.

1. The method of coloring substantially rigid 3 dimensional articles including glassware, by the steps of applying a copolymer of epoxy and acrylic resins having good adhesion characteristics directly onto the outer portion of the article by an application step selected from the group consisting of spraying, dipping, flow coating and Digital Ink Jet Printing

2. The method as set forth in claim 1 wherein said copolymer of epoxy and acrylic resins are a HexiLok coating material; said method including the step of curing said HexiLok coating, by an initial short time exposure to UV light.

3. The method as set forth in claim 2, including completing said curing of said HexiLok coating by exposing said colored article to 300 deg. F. heat for 2 minutes, after said initial short time exposure UV curing.

4. The method of decorating substantially rigid, cylindrical glassware, ceramic or metal articles by applying coloured ink directly onto the outer surface of said articles by way of Digital Ink Jet (DIJ) printing, using HexiLok inks.

5. The method of decorating articles as set forth in claim 4, by applying at least one color to a predetermined portion of said article by DIJ printing, wherein said at least one color is substantially white.

6. The method as set forth in claim 5, including applying a plurality of further HexiLok digital ink colors in pre-planned relation with said first substantially white color.

7. The method as set forth in claim 6, including the step of curing each said HexiLok ink colour at the time of application by simultaneous exposure to UV light at the time of each HexiLok ink color application.

8. The method as set forth in claim 6 including the step of curing said HexiLok ink after all colors have been applied, for 2 minutes at 300 deg. F. heat.

9. The method of enhancing the break resistance of glassware by applying a composite shock-absorber coating to a glass article having a HexiLok undercoating on the article, to which undercoating said shock-absorber coating is applied.

10. The method as set forth in claim 9 including the steps of applying and partially UV curing said HexiLok undercoating so as to leave said undercoating tacky, to promote adhesion of said shock-absorber coating to said undercoating.

11. The method as set forth in claim 9, wherein said shock-absorber coating is a predetermined thickness of cross-linked ethylene acrylic acid copolymer.

12. The method as set forth in claim 11 wherein said shock-absorber coating is applied as a powder and is melted into a smooth coating in a conveyorized oven.

13. The method as set forth in claim 9 including applying a clear or colored HexiLok composite coating over the entire outside surface of said article by way of spraying, dipping or flow coating, after said shock absorber coating is applied.

14. The method as set forth in claim 9 including the step of applying a two stage curing process to the complete composite coating, firstly a one second UV cure, then 2 minutes exposure of heat at 300 deg. F. immediately after the coating has been applied.

15. The method as set forth in claim 9, further including applying a HexiLok sealing coating over said shock absorber coating, curing same, applying graphic decoration by way of programmed multi-coloured DIJ printing on said sealing coating, and curing same.

16. The method as set forth in claim 2, wherein said initial curing step is provided by a UV Light Emitting LED unit that travels with the article being decorated and simultaneously cures each application of said HexiLok coating material as it is applied.

17. The method as set forth in claim 1 wherein said combination of epoxy and acrylic resins are a HexiLok coating material; said method including the step of curing said HexiLok coating, by a three second time exposure to UV light.

18. A decorated cylindrical article having a coloured ink decoration applied to the outer surface thereof, wherein said decoration is of Hexilok ink, applied by DIJ printing, spraying, flow coating or dip coating.

19. The method as set forth in claim 4, wherein said Hexilok inks, consisting of organic resins and dyes, are fully cured, making the decoration on said articles food safe.
